(19) United States
(12) Patent Application Publication
(10) Pub. No.: US 2022/0234342 A1
(43) Pub. Date: Jul. 28, 2022

(54) METHOD OF ATTACHING ELASTIC PROTECTIVE FILM ON OBJECT

(71) Applicant: Primax Electronics Ltd., Taipei (TW)

(72) Inventors: Ming-Han Wu, Taipei (TW); Yi-Wei Chen, Taipei (TW)

(21) Appl. No.: 17/212,277

(22) Filed: Mar. 25, 2021

(30) Foreign Application Priority Data
Jan. 27, 2021 (TW) 110103039

(51) Int. Cl. B32B 37/12; G06F 3/02; B32B 38/00; B32B 7/12; B32B 3/30

(52) U.S. Cl. CPC B32B 37/12; G06F 3/0202; B32B 2457/00; B32B 7/12; B32B 3/30; B32B 38/0004

(57) ABSTRACT

A method of attaching an elastic protective film on an object is provided. Firstly, the object is provided. Then, an adhesive layer is installed on the object. Then, the elastic protective film is provided. Then, a buffering element is provided. Then, a piercing element is provided. A side of the piercing element facing the buffering element includes plural needle-like structures. Then, the piercing element and the buffering element are pressed on the elastic protective film, the adhesive layer and the object along a first direction. Consequently, the buffering element and the elastic protective film are pierced by the plural needle-like structures. Then, the piercing element and the buffering element are removed along a second direction, wherein the second direction is opposite to the first direction.

### FIELD OF THE INVENTION

The present invention relates to an attaching method, and more particularly to a method of attaching an elastic protective film on an object.

### BACKGROUND OF THE INVENTION

Conventionally, the keyboard user may additionally place a layer of elastic protective film on a top surface of a keyboard device. Due to the elastic protective film, the keyboard device has the waterproof and dustproof functions. However, since the elastic protective film is not fixed on the keyboard device, the elastic protective film is readily shifted or slid when the keyboard device is operated by the user.

Moreover, when the elastic protective film is attached and fixed on the keyboard device, some drawbacks occur. For example, since bubbles are readily retained in the elastic protective film, the overall appearance of the keyboard device and the flatness of the elastic protective film are adversely affected.

### SUMMARY OF THE INVENTION

The present invention provides a method of attaching an elastic protective film on an object. Especially, the present invention provides a method of attaching and fixing an elastic protective film on a keyboard device and a keyboard device using the attaching method. According to the attaching method of the present invention, the bubbles can be removed during the process of attaching the elastic protective film on the object (e.g., the keyboard device).

In accordance with an aspect of the present invention, a method of attaching an elastic protective film on an object is provided. The method includes the following steps. Firstly, the object is provided. The object has a first surface. Then, an adhesive layer is installed on the first surface. Then, the elastic protective film is provided. The elastic protective film has a second surface and a third surface. The second surface and the third surface are opposed to each other. The second surface faces the adhesive layer. Then, a buffering element is provided. The buffering element has a fourth surface and a fifth surface. The fourth surface and the fifth surface are opposed to each other. The fourth surface faces the third surface. Then, a piercing element is provided. A side of the piercing element facing the fifth surface includes plural needle-like structures. Then, the piercing element and the buffering element are pressed on the elastic protective film, the adhesive layer and the object along a first direction. Consequently, the buffering element and the elastic protective film are pierced by the plural needle-like structures. Then, the piercing element and the buffering element are removed along a second direction, wherein the second direction is opposite to the first direction.

In an embodiment, when the elastic protective film is pierced by the plural needle-like structures, plural perforations running through the second surface and the third surface are formed in the elastic protective film. Moreover, after the piercing element is removed, the perforations are automatically shrunken as pores.

In an embodiment, in the step of pressing the piercing element and the buffering element on the elastic protective film, the adhesive layer and the object, bubbles that are present in a region between the elastic protective film and the adhesive layer are exited from the perforations.

In an embodiment, the elastic protective film is made of silicone.

In an embodiment, the buffering element is a foam structure.

In accordance with another aspect of the present invention, a method of attaching an elastic protective film on a keyboard device is provided. The method includes the following steps. Firstly, the keyboard device is provided. The keyboard device includes a frame member and plural keys. The frame member includes an outer frame. The plural keys are disposed within the outer frame. The outer frame has a first surface. Then, an adhesive layer is installed on the first surface. Then, the elastic protective film is provided. The elastic protective film has a second surface and a third surface. The second surface and the third surface are opposed to each other. The second surface faces the adhesive layer. Then, a buffering element is provided. The buffering element has a fourth surface and a fifth surface. The fourth surface and the fifth surface are opposed to each other. The fourth surface faces the third surface. Then, a piercing element is provided. A side of the piercing element facing the fifth surface comprises plural needle-like structures. Then, the piercing element and the buffering element are pressed on the elastic protective film, the adhesive layer and the outer frame along a first direction. Consequently, the buffering element and the elastic protective film are pierced by the plural needle-like structures. Then, the piercing element and the buffering element are removed along a second direction, wherein the second direction is opposite to the first direction.

In an embodiment, when the elastic protective film is pierced by the plural needle-like structures, plural perforations running through the second surface and the third surface are formed in the elastic protective film. Moreover, after the piercing element is removed, the perforations are automatically shrunken as pores.

In an embodiment, in the step of pressing the piercing element and the buffering element on the elastic protective film, the adhesive layer and the outer frame, bubbles that are present in a region between the elastic protective film and the adhesive layer are exited from the perforations.

In an embodiment, the elastic protective film is made of silicone.

In an embodiment, the buffering element is a foam structure.

In accordance with another aspect of the present invention, a keyboard device is provided. The keyboard device includes plural keys, a frame member, an adhesive layer and an elastic protective film. The frame member includes an outer frame. The plural keys are disposed within the outer frame. The outer frame has a first surface. The adhesive layer is installed on the first surface. The elastic protective film is attached on the adhesive layer. The elastic protective film has a second surface and a third surface. The second surface and the third surface are opposed to each other. The adhesive layer and plural keys are covered by the second surface. In addition, plural pores run through the second surface and the third surface.

In an embodiment, each pore has a first opening in the second surface and a second opening in the third surface. A size of the second opening is larger than a size of the first opening.

In an embodiment, the elastic protective film is made of silicone.

The above objects and advantages of the present invention will become more readily apparent to those ordinarily skilled in the art after reviewing the following detailed description and accompanying drawings, in which:

### BRIEF DESCRIPTION OF THE DRAWINGS

FIGS. 1A to 1F are schematic cross-sectional views illustrating the steps of a method of attaching an elastic protective film on an object according to a first embodiment of the present invention;

FIG. 2 is a schematic enlarged view illustrating a portion of the structure as shown in FIG. 1F;

FIGS. 3A to 3C schematically illustrate the steps of a method of attaching an elastic protective film on a keyboard device according to a second embodiment of the present invention; and

FIG. 4 is a schematic enlarged view illustrating a portion of the keyboard device as shown in FIG. 3C and taken along the line 4-4.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown.

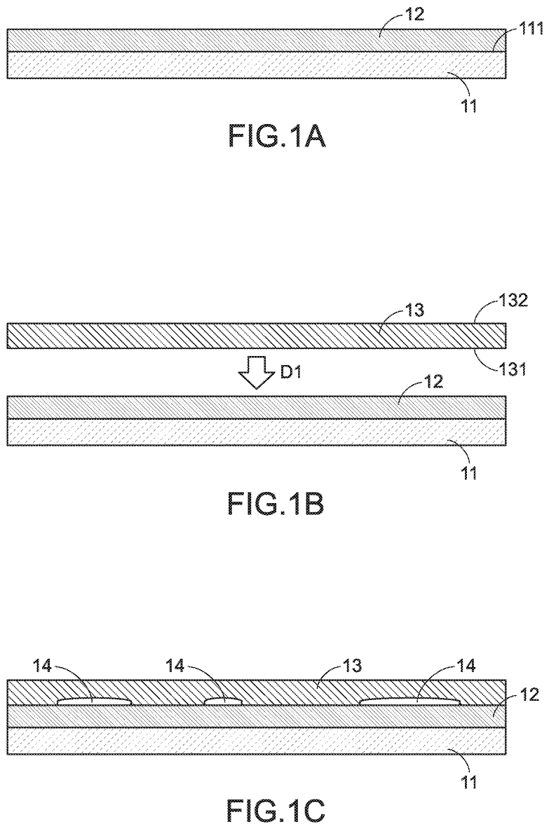

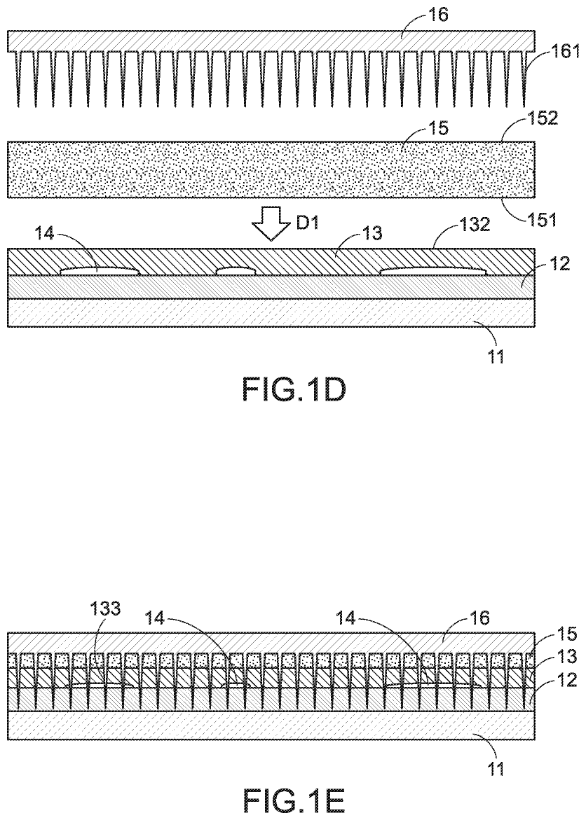

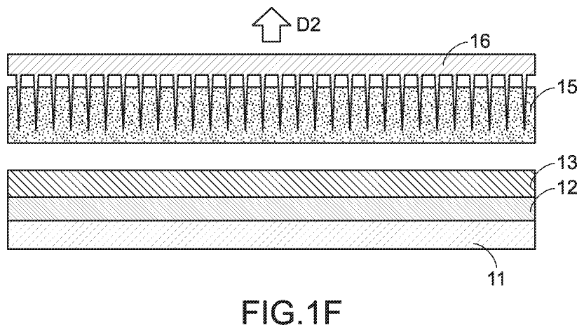

A method of attaching an elastic protective film on an object according to a first embodiment of the present invention will be illustrated with reference to FIGS. 1A to 1F. FIGS. 1A to 1F are schematic cross-sectional views illustrating the steps of a method of attaching an elastic protective film on an object according to a first embodiment of the present invention.

Please refer to FIG. 1A. Firstly, an object 11 and an adhesive layer 12 are provided. The object 11 has a surface 111. The adhesive layer 12 is formed on the surface 111 of the object 11.

Please refer to FIG. 1B. Then, an elastic protective film 13 is provided. The elastic protective film 13 has a surface 131 and another surface 132. The surface 131 and the surface 132 are opposed to each other. The surface 131 of the elastic protective film 13 faces the adhesive layer 12. For example, the elastic protective film 13 is made of silicone.

Please refer to FIG. 1B and FIG. 1C. Then, the elastic protective film 13 is attached on the adhesive layer 12 along a direction D1. Due to the elasticity of the elastic protective film 13, bubbles 14 are unavoidably formed in the region between the elastic protective film 13 and the adhesive layer 12 during the attaching process.

In order to eliminate these bubbles 14 and maintain the attachment relationship between the elastic protective film 13 and the adhesive layer 12, a buffering element 15 and a piercing element 16 are further provided. For example, the buffering element 15 is a foam structure. The buffering element 15 has a surface 151 and another surface 152, which are opposed to each other. The surface 151 of the buffering element 15 faces the surface 132 of the elastic protective film 13. The side of the piercing element 16 facing the buffering element 15 comprises plural needle-like structures 161.

Please refer to FIG. 1D and FIG. 1E. After the buffering element 15 and the piercing element 16 are placed over the elastic protective film 13, a downward force is applied to press the piercing element 16 and the buffering element 15 on the elastic protective film 13, the adhesive layer 12 and the object 11. At the same time, the buffering element 15 and the elastic protective film 13 are pierced by the needle-like structures 161 of the piercing element 16. After the elastic protective film 13 is pierced by the needle-like structures 161 of the piercing element 16, plural perforations 133 are formed in the elastic protective film 13. These perforations 133 run through the surface 131 and the surface 132. While the downward force is applied to press the associated components, the buffering element 15 provides a uniform and flat pressure to the elastic protective film 13. Consequently, the bubbles 14 that are originally present in the region between the elastic protective film 13 and the adhesive layer 12 will be exited to the regions between the buffering element 15 and the piercing element 16 along the perforations 133.

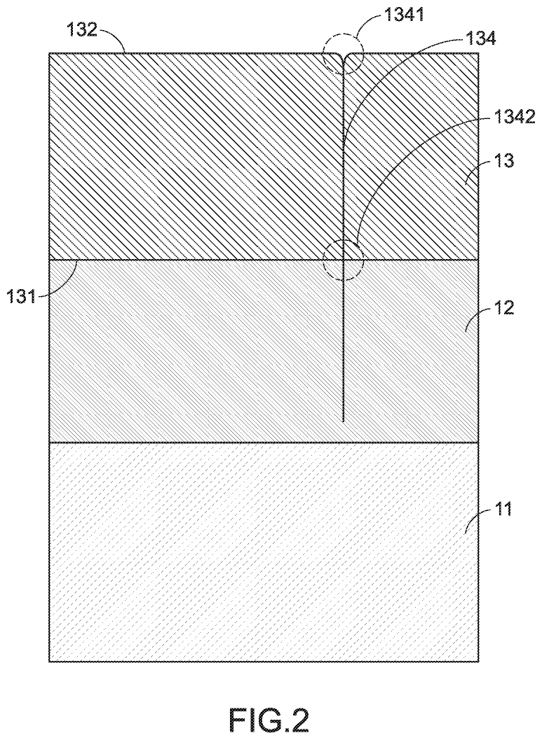

Please refer to FIG. 1F. Afterwards, the piercing element 16 and the buffering element 15 are removed along another direction D2. The direction D2 is opposite to the direction D1. After the piercing element 16 is removed, the perforations 133 running through the surface 131 and the surface 132 of the elastic protective film 13 are automatically shrunken as pores 134 (see FIG. 2) because of the material of the elastic protective film 13. The pores 134 are too small to be visually observed. In other words, the flatness of the elastic protective film 13 is not largely affected.

From the above descriptions, the piercing element 16 is used to form plural perforations 133 in the elastic protective film 13, and the buffering element 15 provides the uniform pressure to the elastic protective film 13. Consequently, the bubbles 14 that are originally present in the region between the elastic protective film 13 and the adhesive layer 12 can be smoothly removed. The resulting structure of the elastic protective film 13 can be shown in FIG. 1F. Under this circumstance, the elastic protective film 13 is placed flat and attached on the object 11.

FIG. 2 is a schematic enlarged view illustrating portions of the elastic protective film 13, the adhesive layer 12 and the object 11 as shown in FIG. 1F. As mentioned above, after the piercing element 16 is removed, the perforations 133 running through the surface 131 and the surface 132 are automatically shrunken as the pores 134 because of the material (e.g., silicone) of the elastic protective film 13. As shown in the enlarged view of FIG. 2, the pore 134 has an opening 1341 in the surface 132 of the elastic protective film 13 and another opening 1342 in the surface 131 of the elastic protective film 13. The size of the opening 1341 is larger than the size of the opening 1342. That is, the pore 134 is tapered from the top side to the bottom side. Due to the structural design of the pore 134, the small bubbles that are not completely removed can be gradually exited from the pore 134. Afterwards, as shown in FIG. 1F, the elastic protective film 13 is placed flat and tightly attached on the object 11. Consequently, the attaching method is completed smoothly.

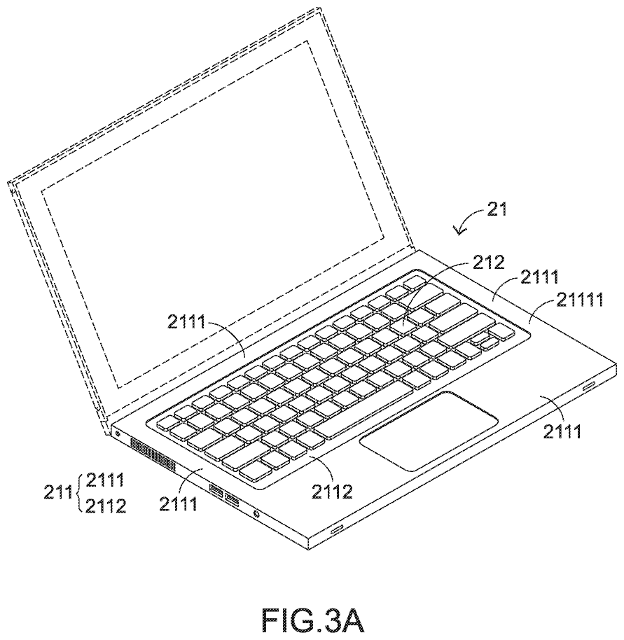

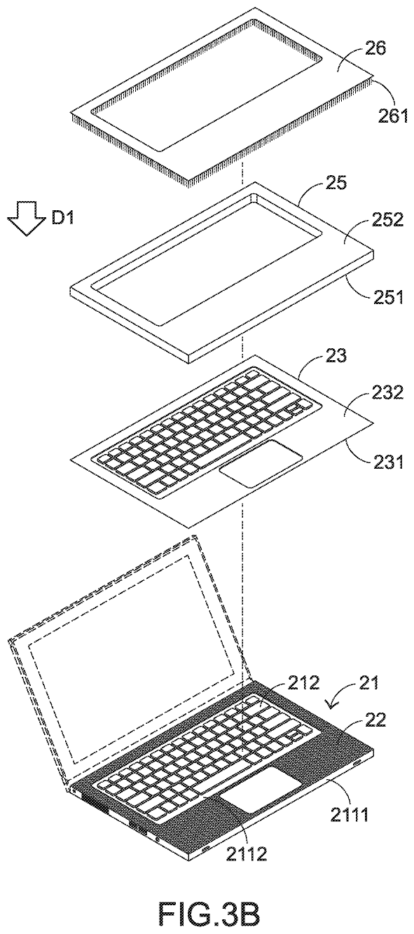

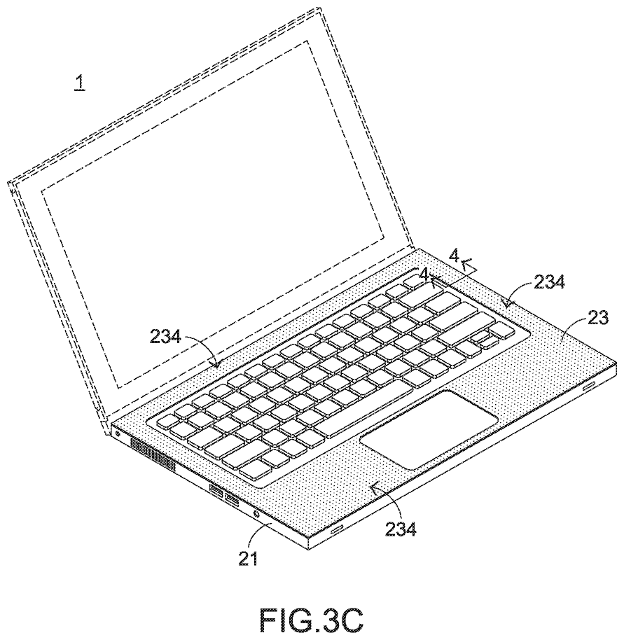

A method of attaching an elastic protective film on a keyboard device according to a second embodiment of the present invention will be illustrated with reference to FIGS. 3A to 3C. FIGS. 3A to 3C schematically illustrate the steps of a method of attaching an elastic protective film on a keyboard device according to a second embodiment of the present invention. For succinctness, the steps of the attaching method of this embodiment similar to those of the first embodiment will be omitted. That is, only the applications of the attaching method on the keyboard device (i.e., an example of the object) will be described.

Please refer to FIG. 3A. Firstly, a keyboard device 21 is provided. The keyboard device is a wired keyboard device or a wireless keyboard device. As shown in FIG. 3A, the keyboard device is used as the keyboard device of a notebook computer. It is noted that the applications of the keyboard device of the present invention are not restricted. The keyboard device 21 comprises a frame member 211 and plural keys 212. The frame member 211 comprises an outer frame 2111. The plural keys 212 are disposed within the outer frame 2111. The outer frame 2111 has a frame surface 21111.

Please refer to FIG. 3B. Then, an adhesive layer 22 is installed on the frame surface 21111 of the outer frame 2111. Then, an elastic protective film 23 is provided. The elastic protective film 23 has a surface 231 and another surface 232. The surface 231 and the surface 232 are opposed to each other. The surface 231 of the elastic protective film 23 faces the adhesive layer 22. For example, the elastic protective film 23 is made of silicone.

Then, a buffering element 25 and a piercing element 26 are provided. For example, the buffering element 25 is a foam structure. The buffering element 15 has a surface 251 and a surface 252, which are opposed to each other. The surface 251 of the buffering element 25 faces the surface 232 of the elastic protective film 23. The side of the piercing element 26 facing the buffering element 25 comprises plural needle-like structures 261.

The following step is similar to that of the first embodiment. After the buffering element 25 and the piercing element 26 are placed over the elastic protective film 23, a downward force is applied to press the piercing element 26 and the buffering element 25 on the elastic protective film 23, the adhesive layer 22 and the outer frame 2111 of the keyboard device 21. At the same time, the buffering element 25 and the elastic protective film 23 are pierced by the needle-like structures 261 of the piercing element 26. After the elastic protective film 23 is pierced by the needle-like structures 261 of the piercing element 26, plural perforations (not shown) are formed in the elastic protective film 23. These perforations 233 run through the surface 231 and the surface 232. While the downward force is applied to press the associated components, the buffering element 25 provides a uniform and flat pressure to the elastic protective film 23. Consequently, the bubbles that are originally present in the region between the elastic protective film 23 and the adhesive layer 22 will be exited to the regions between the buffering element 25 and the piercing element 26 along the perforations.

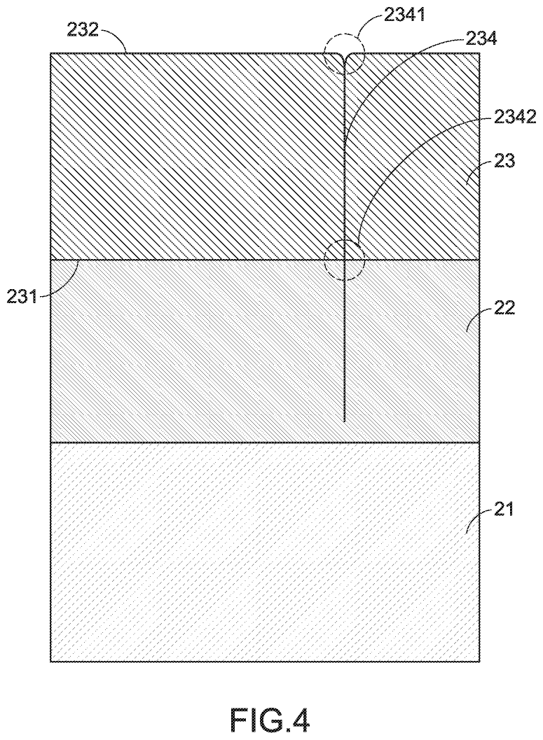

Afterwards, the piercing element 26 and the buffering element 25 are removed along another direction D2. The direction D2 is opposite to the direction D1. Then, the perforations running through the surface 231 and the surface 232 of the elastic protective film 23 are automatically shrunken as pores 234 (see FIG. 3C) because of the material (e.g., silicone) of the elastic protective film 23. The pores 234 are too small to be visually observed. As shown in the enlarged view of FIG. 4, the pore 234 has an opening 2342 in the surface 231 of the elastic protective film 23 and another opening 2341 in the surface 232 of the elastic protective film 23. The size of the opening 2341 is larger than the size of the opening 2342. That is, the pore 234 is tapered from the top side to the bottom side. Due to the structural design of the pore 234, the small bubbles that are not completely removed can be gradually exited from the pore 234. As shown in FIG. 3C, the elastic protective film 23 is placed flat and tightly attached on the keyboard device 21. Consequently, the attaching method is completed smoothly.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A method of attaching an elastic protective film on an object, the method comprising steps of:
providing the object, wherein the object has a first surface;
installing an adhesive layer on the first surface;
providing the elastic protective film, wherein the elastic protective film has a second surface and a third surface, wherein the second surface and the third surface are opposed to each other, and the second surface faces the adhesive layer;
providing a buffering element, wherein the buffering element has a fourth surface and a fifth surface, wherein the fourth surface and the fifth surface are opposed to each other, and the fourth surface faces the third surface;
providing a piercing element, wherein a side of the piercing element facing the fifth surface comprises plural needle-like structures;
pressing the piercing element and the buffering element on the elastic protective film, the adhesive layer and the object along a first direction, so that the buffering element and the elastic protective film are pierced by the plural needle-like structures; and
removing the piercing element and the buffering element along a second direction, wherein the second direction is opposite to the first direction.

2. The method according to claim 1, wherein when the elastic protective film is pierced by the plural needle-like structures, plural perforations running through the second surface and the third surface are formed in the elastic protective film, wherein after the piercing element is removed, the perforations are automatically shrunken as pores.

3. The method according to claim 2, wherein in the step of pressing the piercing element and the buffering element on the elastic protective film, the adhesive layer and the object, bubbles that are present in a region between the elastic protective film and the adhesive layer are exited from the perforations.

4. The method according to claim 1, wherein the elastic protective film is made of silicone.

5. The method according to claim 1, wherein the buffering element is a foam structure.

6. A method of attaching an elastic protective film on a keyboard device, the method comprising steps of:
providing the keyboard device, wherein the keyboard device comprises a frame member and plural keys, wherein the frame member comprises an outer frame, the plural keys are disposed within the outer frame, and the outer frame has a first surface;
installing an adhesive layer on the first surface;
providing the elastic protective film, wherein the elastic protective film has a second surface and a third surface, wherein the second surface and the third surface are opposed to each other, and the second surface faces the adhesive layer;
providing a buffering element, wherein the buffering element has a fourth surface and a fifth surface, wherein the fourth surface and the fifth surface are opposed to each other, and the fourth surface faces the third surface;
providing a piercing element, wherein a side of the piercing element facing the fifth surface comprises plural needle-like structures;
pressing the piercing element and the buffering element on the elastic protective film, the adhesive layer and the outer frame along a first direction, so that the buffering element and the elastic protective film are pierced by the plural needle-like structures; and
removing the piercing element and the buffering element along a second direction, wherein the second direction is opposite to the first direction.

7. The method according to claim 6, wherein when the elastic protective film is pierced by the plural needle-like structures, plural perforations running through the second surface and the third surface are formed in the elastic protective film, wherein after the piercing element is removed, the perforations are automatically shrunken as pores.

8. The method according to claim 7, wherein in the step of pressing the piercing element and the buffering element on the elastic protective film, the adhesive layer and the outer frame, bubbles that are present in a region between the elastic protective film and the adhesive layer are exited from the perforations.

9. The method according to claim 6, wherein the elastic protective film is made of silicone.

10. The method according to claim 6, wherein the buffering element is a foam structure.

11. A keyboard device, comprising:
plural keys;
a frame member comprising an outer frame, wherein the plural keys are disposed within the outer frame, and the outer frame has a first surface;
an adhesive layer installed on the first surface; and
an elastic protective film attached on the adhesive layer, wherein the elastic protective film has a second surface and a third surface, wherein the second surface and the third surface are opposed to each other, the adhesive layer and plural keys are covered by the second surface, and plural pores run through the second surface and the third surface.

12. The keyboard device according to claim 11, wherein each pore has a first opening in the second surface and a second opening in the third surface, wherein a size of the second opening is larger than a size of the first opening.

13. The keyboard device according to claim 11, wherein the elastic protective film is made of silicone.
